(19) United States
(12) Patent Application Publication
(10) Pub. No.: US 2017/0203883 A1
(43) Pub. Date: Jul. 20, 2017

(54) SQUEEZABLE BOTTLE FOR ASEPTIC FILLING WITH VISCOUS FOOD

(71) Applicant: Nestec S.A., Vevey (CH)

(72) Inventors: Andrea RIGARDO, Konolfingen (CH); Fanny CHEVET, Bern (CH)

(21) Appl. No.: 15/106,436

(22) PCT Filed: Dec. 17, 2014
(86) PCT No.: PCT/EP2014/078343

§ 371 Date: Jun. 20, 2016

(30) Foreign Application Priority Data
Dec. 18, 2013 (EP) 13198162.3

(51) Int. Cl. B65D 35/08; B65D 85/72; A61J 1/14; B65D 1/02

(52) U.S. Cl. CPC B65D 35/08; B65D 1/0215; B65D 1/0246; B65D 85/72; A61J 1/1468

(57) ABSTRACT

An aseptically processable semi-rigid bottle is disclosed. The bottle is easily squeezed by hand, without the bottle reassuming its initial shape, thus collapsing and ensuring that it contents are readily emptied.

### FIELD OF INVENTION

The present invention relates to bottles, in particular the present invention relates to aseptically processable bottles that are squeezable and collapsible to empty a content of the bottle.

### BACKGROUND OF INVENTION

Aseptic packaging is usually used for the packaging of spoilable substances; such spoilable substances include foods, beverages and pharmaceuticals.

In aseptic packaging techniques the spoilable substance is sterilised by rapid exposure to heat, rapidly cooled to an ambient temperature and then filled into a sterilised package. The sterilised package is then sealed in a sterile environment. Aseptic packaging techniques retain more nutrients and properties of the spoilable substance and use less energy than retort sterilisation techniques.

Aseptic packaging techniques are often used in applications where the spoilable substance is flowable and in these situations the aseptic packaging techniques utilise squeezable pouches. The squeezable pouches contain the spoilable substance. The squeezable pouches, when squeezed, collapse to allow a content of the squeezable pouches to be readily emptied by the application of pressure. The squeezable pouches are often made up of flexible, multi-layer, multi-materials (e.g. plastics, metals, papers). The flexible, multi-layer, multi-materials (e.g. plastics, metals, papers) are often manufactured to have specific barriers properties to the outside environment.

The squeezable pouches pose numerous problems. Recycling of the squeezable pouches requires extensive resources to process, due to the use of the multi-layer, multi-materials (e.g. plastics, metals, papers) and therefore the squeezable pouches cannot be recycled together with conventional recyclable material. In addition, a shape of a squeezable pouch is obtained by welding different surfaces of the multi-layer, multi-materials (e.g. plastics, metals, papers) together. The welding makes the squeezable pouches undesirable to hold since the welding(s) generate sharp edges. The squeezable pouches are undesirable to handle and store since the flexible, multi-layer, multi-materials are not rigid. The squeezable pouches are difficult to manufacture because manufacturing of single layers of the flexible, multi-layer, multi-materials is required, which requires different processing conditions for each single layer of the flexible, multi-layer, multi-materials. Furthermore a spout and a cap need to be welded to the squeezable pouches. Due to the flexible nature of the squeezable pouches a filling of the squeezable pouches with the flowable substance is not efficient. Due to the flexible nature of the squeezable pouches, the squeezable pouches are prone to breakage during filling with the flowable substance and during transport. Due to the flexible nature of the squeezable pouches, the squeezable pouches need to be filled with an internal pressure greater than environmental pressure to maintain a shape of the squeezable pouches; however this variation of pressure can also lead to the squeezable pouches rupturing.

GB 775217 discloses a spherical container with an outlet tube attached thereto. The spherical container is for a liquid. The spherical container is also filled with a gas to maintain its shape when full of liquid and therefore suffers deficiencies as noted with respect to squeezable pouches. The spherical container is not easy to store and use because of its shape. The spherical container is manufactured from plastic and thermoplastic material which is resilient to stretching. The outlet tube attached to the spherical container is rigid; therefore a limitation as to the compressibility of the spherical container exists in that not all of the liquid can be effectively emptied, as some of the liquid remains in the rigid outlet tube. The spherical container is unsuitable for filling aseptically.

EP 0599421 discloses a bottle made of a flexible material. The bottle is designed to be folded by means of grooves on the surface of the bottle; therefore the bottle requires specific manufacturing methods to form the grooves. The bottle is held in a folded position by means of a fastening element. The bottle requires extensive force to fold and thus empty its contents. The bottle is not completely collapsible when squeezed by the application of relatively low pressure and therefore not all of a content of the bottle is readily emptied.

WO 98/31952 discloses a plastic bottle that is easily crushed when empty. The plastic bottle has a plurality of foldable creases on a surface of the plastic bottle.

WO 2006/005616 discloses a squeezable container for chilled products. Walls of the squeezable container are manufactured from polyethylene terephthalate (PET). PET has many drawbacks; PET is unsuitable for aseptic processing. PET does not provide specific barriers properties to the outside environment. The squeezable containers are difficult to manufacture and require specialised forms to make the required shapes. In addition the properties of PET have numerous drawbacks when squeezed; a first drawback exists because when PET bottles are squeezed, the PET bottle generates loud crunching noises, which can be perceived negatively by a consumer, a further drawback exists because the PET bottles by their inherent rigid nature are difficult to squeeze in a controlled and regular manner, therefore it is not possible to squeeze the PET bottle to deliver a content of the PET bottle with a controlled rate.

WO 2008/095849 discloses a collapsible container for non-flowable food products. The collapsible container is manufactured by injection blowing thermoplastic material(s). The thermoplastic material(s) include polyethyleneterephtalate (PET), polyethylenenaphtalate (PEN), polyethyleneterephtalateglycol (PETG), polypropylene (PP) or a combination thereof. Such thermoplastic material(s) are unsuitable for aseptic processing and do not provide specific barriers properties to the outside environment. The collapsible container comprises helical groves in the form of bellows such that the container can only be squeezed in a direction perpendicular to the direction of the helical groves. Since the collapsible container can only be squeezed in a direction perpendicular to the direction of the helical groves, the collapsible container is cumbersome to use for children and the elderly. The collapsible container requires specialised injection blowing techniques to form the helical grooves. A neck of the collapsible container is rigid; meaning that not all of the non-flowable food product can be effectively emptied, as some of the non-flowable food product remains in the rigid neck. The helical groves of the collapsible container trap the non-flowable food product meaning that not all of the non-flowable food product can be effectively emptied, as some of the non-flowable food product remains in the helical grooves.

WO 2010/080280 discloses a partially collapsible bottle. The partially collapsible bottle has a rigid wall and a semi rigid wall. The rigid wall is collapsible by the application of a first pressure and a semi rigid wall is collapsible by the application of a different second pressure. A neck of the partially collapsible bottle also has a rigid wall and a semi rigid wall. The neck is collapsible by the application of a first pressure and the application of a different second pressure. Since the partially collapsible bottle requires the application of different pressures to collapse the bottle, the partially collapsible container is cumbersome to use for children and the elderly. Since the partially collapsible bottle is partially collapsible it is not possible to dispense all of the contents of the partially collapsible bottle when it is squeezed.

There is a need to overcome at least some of the aforementioned drawbacks by providing a squeezable container that when squeezed by the application of relatively low pressure (i.e. hand), collapses to allow a content of the squeezable container to be readily emptied.

### SUMMARY OF INVENTION

The present invention according to a first aspect provides a semi-rigid bottle, wherein the bottle is made from aseptically processable plastics and is formstable. The bottle is squeezable and collapsible by applying a radially inward crush grip force without reassuming its initial shape after collapsing it. The walls of the bottle contain at least one oxygen and light barrier layer.

In an embodiment the wall of the bottle is made from a multilayer material.

In an embodiment a volume of the bottle is between 5 ml to 250 ml.

In an embodiment the oxygen barrier layer is an EVOH layer.

In an embodiment the wall comprises a first layer of a thermoplastic polyolefin selected from one of linear low-density polyethylene (LLDPE), low-density polyethylene (LDPE), medium-density polyethylene (MDPE), high-density polyethylene (HDPE) or polypropylene (PP) and a second layer of ethylene vinyl alcohol (EVOH).

In an embodiment the wall comprises a multilayer of MDPE/EVOH/MDPE.

In an embodiment the bottle is collapsible by at least 30% of its volume, preferably at least 60% of its volume, even more preferred by 90% of its volume, when applying a crushing grip force of 2.5 N to 10 N, preferably 4N to 8 N.

In an embodiment the bottle has a shape and a volume to fit in a human hand.

In an embodiment the bottle is obtainable by extrusion blow moulding.

In an embodiment the bottle has a self-standing shape.

In an embodiment the bottle is free of metal layers with the exception of a metal foil sealing a mouth of the bottle.

In an embodiment a body of the bottle is substantially linear.

In an embodiment a wall thickness of the bottle is between 10 μm and 150 μm, preferably between 30 μm and 120 μm, more preferred between 50 μm and 100 μm.

The present invention according to a second aspect provides a packaged viscous food, beverage or pharmaceutical, being aseptically packaged in the bottle.

In an embodiment a weight of the bottle is between 3% and 8%, preferably between 4% and 6% of the weight of the packaged viscous food, beverage or pharmaceutical without the bottle.

### BRIEF DESCRIPTION OF FIGURES

FIG. 1 shows a bottle according to the present invention.

FIGS. 2a and 2b shows a bottle being collapsed according to the present invention.

### DETAILED DESCRIPTION

For a complete understanding of the present invention and the advantages thereof, reference is made to the following detailed description.

It should be appreciated that the various aspects and embodiments of the detailed description as disclosed herein are illustrative of the specific ways to make and use the invention and do not limit the scope of invention when taken into consideration with the claims and the detailed description. It will also be appreciated that features from different aspects and embodiments of the invention may be combined with features from different aspects and embodiments of the invention.

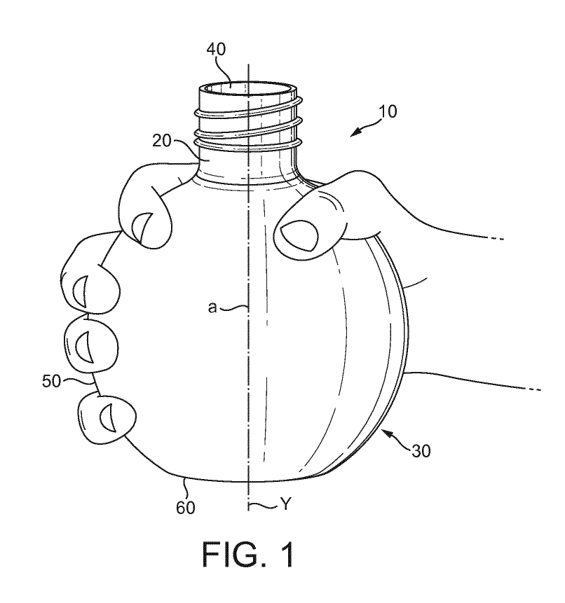

As used herein the term “bottle” 10, as shown with reference to FIG. 1, means a bottle in the conventional sense, i.e. a container with a neck 20 that is narrower than a body 30 of the bottle 10. The bottle 10 also has a mouth 40. The body 30 and/or the walls 50 are devoid of helical grooves and devoid of helical ridges. The body 30 and/or the walls 50 can be substantially linear; nevertheless the body 30 and/or the walls 50 can be formed into various shapes depending in the intended use of the bottle 10.

The term “wall” 50 with respect to the bottle 10 means the wall 50 of the bottle 10 and includes all sides/surfaces of the bottle 10 such as the body 30 sides/surfaces, the neck 20 sides/surfaces, the mouth 40 sides/surfaces and a base 60 sides/surfaces.

The term “aseptically processable plastics” means at least one plastic that can be processed in aseptic conditions without causing any degradation to the plastic and/or degradation of any properties of the plastic.

The term “crushing grip force” refers to the fact that the bottle (shape and material) is designed such that any external force applied to bottle wall, having a direction as exerted typically by a human hand, will lead to a squeezing and collapsing of the bottle.

As shown in FIG. 1, in a first aspect the present invention relates to the bottle 10 which is semi-rigid. The bottle 10 is made from aseptically processable plastics. The bottle 10 is formstable. The bottle 10 is squeezable and collapsible upon application of a radially-inward crushing grip force without the bottle reassuming its initial shape after collapsing.

The wall 50 of the bottle 10 contains at least one oxygen barrier layer and light barrier layer.

A radially-inward crushing grip force can be applicable to the bottle 10 in a direction substantially perpendicular to the axis Y as shown in FIG. 1. The axis Y is an axis that runs from the centre of the mouth 40 to the centre of the base 60 of the bottle 10.

However is not essential that radially-inward crushing grip force is applied to the bottle 10 in a direction substantially perpendicular to the axis Y as shown in FIG. 1 and the radially-inward crushing grip force can be applied in all directions including a direction of the axis Y and any combination and angle variation thereof. The bottle 10 is made from the aseptically processable plastics. The aseptically processable plastics define the wall 50 of the bottle 10.

The aseptically processable plastics that define the wall 50 of the bottle 10 can be a single aseptically processable plastic or a mixture thereof The aseptically processable plastics that define the wall 50 of the bottle 10 can be in the form of layers of aseptically processable plastics or a mixture thereof

The aseptically processable plastics can be for example, single materials, mixtures of, multilayer's of, or combinations thereof, of:
Thermoplastic polyolefin(s), such as: linear low-density polyethylene (LLDPE), low-density polyethylene (LDPE), medium-density polyethylene (MDPE), high-density polyethylene (HDPE) and polypropylene (PP).
ethylene vinyl alcohol (EVOH).
A polyolefin base plastic.
A thermoplastic polyolefin (selected from of the above) and ethylene vinyl alcohol (EVOH).

The wall 50 of the bottle 10 contains at least one oxygen barrier layer and light barrier layer, such as e.g. the mentioned EVOH layer.

It is preferable that the wall 50 is a multilayer of the aseptically processable plastics and is arranged as any one of the thermoplastic(s) polyolefin as noted above and ethylene vinyl alcohol (EVOH). Most preferably the wall 50 is a multilayer of the aseptically processable plastics and is arranged as medium-density polyethylene (MDPE)/ethylene vinyl alcohol (EVOH)/medium-density polyethylene (MDPE).

When the bottle 10 is squeezed and collapsed by application of the radially-inward crushing grip force the bottle 10 no longer reassumes its shape. In this regards the bottle 10 can be collapsed by at least 30% of its volume, preferably at least 60% of its volume, even more preferred by 90% or even 95% of its initial volume, preferably when applying a crushing grip force of 2.5 N to 10 N, preferably 4N to 8 N when measured perpendicular to a tangent of the bottle 10 wall 50.

The bottle 10 according to present invention is intended for squeezing by the human hand, including adults and children. Therefore it is preferable that the bottle 10 has a shape and volume to fit in a human hand. The shape and volume of the bottle 10 is designed according to the user.

It is preferable that the bottle 10 has a volume of between 5 ml to 250 ml. The bottle 10 can have a volume of 10 ml, 25 ml, 50 ml, 75 ml, 100 ml, 125 ml, 150 ml, 175 ml, 200 ml, 225 ml.

The dimensions such as radius and height of the body 30 determine the volume of the bottle 10. Thus by having a bottle 10 with a relatively low radius and height of the body 30 a relatively small bottle 10 is useful for handling by smaller hands. Conversely by having a bottle 10 with a relatively high radius and height of the body 30 a relatively large bottle 10 is useful for handling by larger hands.

When the bottle 10 has a relatively small volume, i.e. with a volume 5 ml to 50 ml, the bottle 10 is useful for providing “shots” of its contents. This is useful for example where the bottle 10 contains nutritional foods or pharmaceuticals that need to be administered as “shots”. When the bottle 10 has a relatively higher volume, i.e. with a volume 50 ml to 250 ml, the bottle 10 is useful for providing on-the-go consumption of its contents. This is useful for example where the bottle 10 contains for example a drink. Of course it is to be appreciated that the volume of the bottle is not limited to these scenarios.

It can be desirable to manipulate the properties of the aseptically processable plastics that define the wall 50 of the bottle 10. The aseptically processable plastics that define the wall 50 of the bottle 10 can be transparent. This ensures that a content of the bottle 10 can be visualised so that a user knows how much content of the bottle 10 remains. This also has the further advantage, that for example when the bottle 10 is filled during aseptic filling it is easy to visualise the filling of the bottle 10 in quality control.

The aseptically processable plastics that define the wall 50 of the bottle 10, preferably comprise ethylene vinyl alcohol (EVOH). Ethylene vinyl alcohol (EVOH) provides an oxygen barrier to the bottle 10. Ethylene vinyl alcohol (EVOH) also maintains flavours of any contents within the bottle 10.

The aseptically processable plastics that define the wall 50 of the bottle 10, preferably comprise at least one linear low-density polyethylene (LLDPE), low-density polyethylene (LDPE), medium-density polyethylene (MDPE), high-density polyethylene (HDPE). These polyethylenes provide a water/moisture barrier to the bottle 10 and thus prevent any water/moisture entering or leaving the bottle 10. These polyethylenes therefore maintain an integrity (e.g. freshness) of the contents of the bottle 10 and prevent any degradation of the bottle 10 that could be caused by water/moisture.

The aseptically processable plastics that define the wall 50 of the bottle 10 may be selected to absorb UV light and/or be coloured. This ensures that the contents of the bottle 10 can be protected from light, which may degrade the contents of the bottle 10.

The bottle 10 according to the present invention is manufactured by extrusion blow moulding. Extrusion blow moulding has the advantage that aseptically processable plastics and the bottle 10 can be manufactured with a uniform thickness. During extrusion blow moulding pin and bushing tools of the extrusion blow moulding apparatus can be adjusted to adjust the thickness of the bottle 10. Extrusion blow moulding has the advantage that the bottle 10 can be manufactured easily into desired shapes. Extrusion blow moulding has the advantage that the mouth 40, neck 20 and body 30 are singly integrated into the bottle 10. Therefore extrusion blow moulding avoids a need for separate welding of constituents of the bottle 10, which could provide weak points in the bottle 10 structure. Since the mouth 40, neck 20 and body 30 are singly integrated into the bottle 10, the entire bottle 10 can be squeezed so that the bottle 10 collapses to allow a content of the bottle 10 to be readily emptied from the entire bottle 10 (including the neck 20, the mouth 40 and the body 30).

The bottle 10 according to the present invention is suitable for filling in aseptic conditions, and for packaging and dispensing a flowable substance.

When the bottle 10 according to the present invention is filled in aseptic conditions, the bottle 10 is sealed. The bottle 10 can be sealed by a material that is welded to an opening of the mouth 40. The bottle 10 can be sealed by lid or a screw cap on the opening of the mouth 40. The bottle 10 can be sealed by a material that is welded to an opening of the mouth 40 and a combination of the lid or screw cap to the opening of the mouth 40. The sealing of the bottle 10 is often dependent on the nature of the contents to be filled in the bottle 10. It is preferable that the bottle is sealed with a metal foil such as aluminium.

A wall 50 thickness of the bottle 10 can be between 10 μm and 150 μm, preferably between 30 μm and 120 μm, more preferably between 50 μm and 100 μm.

The flowable substance includes foods and pharmaceuticals that can be in the form of a powder, liquid, gel or paste-like materials which do not flow under their own weight. When the flowable substance is in the form of a powder, the powder is typically intended to be reconstituted with liquid before consumption. In such case, liquid such as water is added by the consumer directly into the bottle 10 such as to form a liquid, gel or paste-like material to be consumed. The flowable substance is usually a substance that is spoilable and thus requires aseptic packaging to maintain its usability.

Flowable substances include for example foods, beverages and pharmaceuticals. Preferred types of flowable substances include milk-based products, yogurt, fruit and/or vegetable preparations and cereal-based products. Such products are most preferably intended for children or elderly people. When the flowable substance is a food, it can be intended to be consumed as a snack or as a complete nutrition.

The bottle 10 of the present invention is surprisingly light weight and when used with viscous food, beverage or pharmaceutical a weight of the bottle is between 3% and 8%, preferably between 4% and 6% of the weight of the bottled viscous food, beverage or pharmaceutical without the bottle 10.

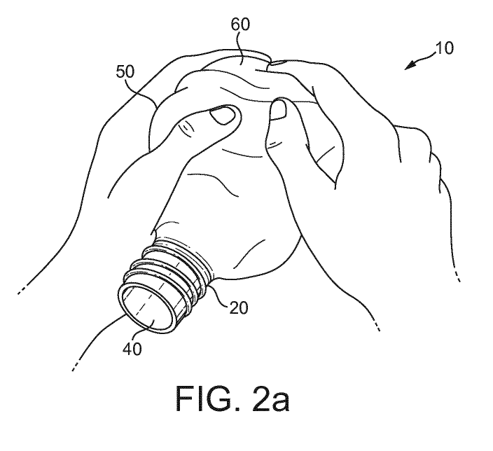

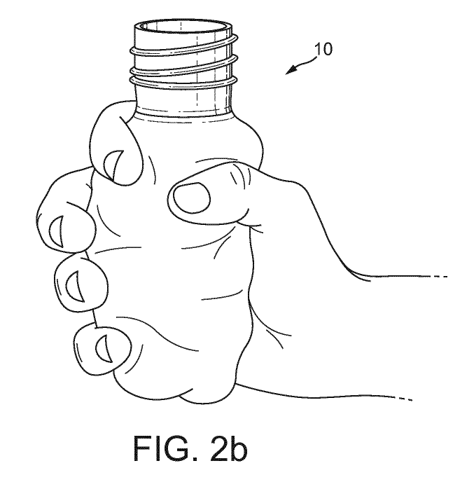

As shown with respect to FIGS. 2a and 2b, the bottle 10 according to the present invention is (as noted) manufactured from aseptically processable plastics. The bottle 10 can be used in all aseptic environments and filled aseptically. Therefore flowable substances can be filled into the bottle at ambient temperatures and then refrigerated. This process is much less energy intense than retort sterilisation processes.

The aseptically processable plastics of the bottle 10, according to the present invention ensure that the bottle 10 can be readily recycled by conventional techniques.

The shape of the bottle 10 of the present invention is conventional, therefore the bottle 10 of the present invention is easy to hold, fill, package and store.

Since the entire bottle 10 is manufactured from aseptically processable plastics with a relatively thin wall and specific deformation constraints a user can easily squeeze the bottle 10 by the application of relatively low pressure (i.e. hand) so that the bottle 10 collapses to allow a content of the bottle 10 to be readily emptied from the entire bottle 10 (including the neck 20, the mouth 40 and the body 30). This is important, for example when the bottle 10 is used by children and the elderly. Furthermore since the entire bottle 10 can be squeezed in all directions, as shown with respect to FIGS. 2 and 2a, this ensures the contents of the bottle 10 are efficiently emptied. Since the entire bottle 10 can be squeezed in all directions this is beneficial for environmental waste disposal, as the bottle 10 when empty takes up little space. The bottle 10 can also advantageously be squeezed in a controlled manner, in order to deliver the product to the consumer at a controlled rate according to consumer's needs and desires.

Since the entire bottle 10 is manufactured from aseptically processable plastics with a relatively thin wall and specific deformation constraints the bottle 10 provides a relatively rigid structure that can maintain the shape of a conventional bottle. This allows the bottle 10 according to the present invention to be easily filled via its mouth 40 as the bottle 10 is not liable to fall over. A rigid structure of bottle 10 allows the bottles 10 to be transported when full avoiding a likelihood of the bottles breaking. Since the bottle 10 is in the form of a rigid structure there is no need to add gas to the inside of the bottle 10 to maintain its shape.

The bottle 10 according to the present invention is devoid of any sharp edges as apparent from pouches, since it is in the shape of a conventional bottle and is made from extrusion blow moulding.

The bottle 10 according to the present invention can be squeezed such that there are no noises during the squeezing of the bottle 10.

Since the entire bottle 10 is manufactured from aseptically processable plastics with a relatively thin wall and specific deformation constraints, the bottle 10 has a slightly elastic nature. The slightly elastic nature of the bottle 10 facilitates effective and controlled squeezing and collapsing of the bottle 10.

Having thus described the present invention and the advantages thereof, it should be appreciated that the various aspects and embodiments of the present invention as disclosed herein are merely illustrative of specific ways to make and use the invention.

The various aspects and embodiments of the present invention do not limit the scope of the invention when taken into consideration with the appended claims and the forgoing detailed description.

What is desired to be protected by Letters Patent is set forth in the following claims:

1. A semi-rigid bottle, wherein the bottle:
is made from aseptically processable plastics;
is formstable;
is squeezable and collapsible by a radially-inwardly directed crushing grip force, without the bottle reassuming its initial shape after collapsing; and
has a wall that contains at least one oxygen and light barrier layer.

2. The bottle according to claim 1, wherein the wall of the bottle is made from a multilayer material.

3. The bottle according to claim 1, wherein a volume of the bottle is between 5 ml to 250 ml.

4. The bottle according to claim 1, wherein the oxygen barrier layer is an EVOH layer.

5. The bottle according to claim 1, wherein the wall comprises a first layer of a thermoplastic polyolefin selected from the group consisting of linear low-density polyethylene, low-density polyethylene, medium-density polyethylene, high-density polyethylene, and polypropylene and a second layer of ethylene vinyl alcohol.

6. The bottle according to claim 1, wherein the wall comprises a MDPE/EVOH/MDPE multilayer.

7. The bottle according to claim 1, which can be collapsed by at least 30% of its volume when applying a crushing grip force of 2.5 N to 10 N.

8. The bottle according to claim 1, wherein the bottle has a shape and volume to fit in a human's hand.

9. The bottle according to claim 1, which is obtainable by extrusion blow molding.

10. The bottle according to claim 1, which has a self-standing shape.

11. The bottle according to claim 1, which is free of metal layers with the exception of a metal foil sealing the bottle mouth.

12. The bottle according to claim 1, wherein the body of the bottle is substantially linear.

13. The bottle according to claim 1, which has a wall thickness of between 10 μm and 150 μm.

14. A packaged viscous food, beverage or pharmaceutical, aseptically packaged in a bottle comprising a semi-rigid bottle, wherein the bottle:
is made from aseptically processable plastics;
is formstable;
is squeezable and collapsible by a radially-inwardly directed crushing grip force, without the bottle reassuming its initial shape after collapsing; and
has a wall that contains at least one oxygen and light barrier layer.

15. The packaged viscous food, beverage or pharmaceutical according to claim 14, wherein a weight of the bottle is between 3% and 8% of the weight of the packaged food, beverage or pharmaceutical without the bottle.
